(19) United States
(12) Patent Application Publication
(10) Pub. No.: US 2005/0284873 A1
(43) Pub. Date: Dec. 29, 2005

(54) Gas cylinder

(76) Inventor: Ian Albert, Avalon, CA (US)

Correspondence Address: FULWIDER PATTON LEE & UTECHT, LLP;HOWARD HUGHES CENTER, 6060 CENTER DRIVE, TENTH FLOOR, LOS ANGELES, CA, 90045, US

(21) Appl. No.: 11/165,708

(22) Filed: Jun. 24, 2005

Related U.S. Application Data
(60) Provisional application No. 60/583,297, filed on Jun. 24, 2004.

(51) Int. Cl. F17C 1/00

(52) U.S. Cl. 220/581

(57) ABSTRACT

A gas cylinder, such as a scuba tank, is formed with raised ribs that extend longitudinally from near the top of the cylinder to near the bottom of the cylinder. The longitudinal ribs may be arcuate and equally spaced along the outside circumference of the cylinder so as to protect the body of the cylinder from damage. The gas cylinder may be made from steel or an aluminum alloy, such that the longitudinal ribs are formed by backward impact extrusion. The gas cylinder may be configured with a cylindrical neck at the top of the body so as to house a valve and valve stem. The gas cylinder may be transported using a wheeled pedestal having an adjustable strap for securing the cylinder to the pedestal. A valve protector with an optional handle and retaining clip is provided.

### CROSS-REFERENCES TO RELATED APPLICATION

This application claims the benefit of U.S. Provisional Patent Application Ser. No. 60/583,297, filed Jun. 24, 2004, the content of which is hereby incorporated herein by reference.

### BACKGROUND OF THE INVENTION

The present invention relates to gas cylinders, and more particularly to mixed gas cylinders, compressed air cylinders, oxygen cylinders, carbon dioxide cylinders and acetylene cylinders.

Gas cylinders, such as scuba tanks, are containers for compressed air and other gases, such as oxygen and carbon dioxide. Many gas cylinders are equipped at the top with a valve for regulating gas flow, and the type of a valve will depend on its intended use. Generally, gas cylinders are made of aluminum and/or steel. A steel cylinder is stronger and it can hold more gas per cubic foot than an aluminum cylinder. Steel, however, has some disadvantages, for example, steel is heavier than aluminum, steel rusts, and although the exterior can be galvanized to prevent corrosion, the interior cannot because the zinc used in the galvanizing process may adversely affect gas purity.

Gas cylinders made from aluminum provide an improvement over those made from steel because they are lighter. In addition, aluminum cylinders do not rust; instead, the aluminum oxidizes (i.e., anodizes) and forms a film which protects against corrosion. These advantages, however, are more than offset by the fact that aluminum is a relatively soft metal whose malleable properties make it susceptible to denting and gouging. Damage can also result when gas cylinders roll and hit against one another. Because of this “rolling” tendency, gas cylinders may be placed in a fabric or plastic sleeve; however, the use of such sleeves does not always prevent the tanks from becoming severely damaged.

Furthermore, aluminum cylinders have an exterior surface which (like steel), is smooth and featureless. This makes them difficult to grasp and carry. Accordingly, when they are moved from one location to another, the tendency is to hoist and carry them by the valve stem and this, when repeatedly done, will ultimately cause damage to the valve assembly.

A scuba cylinder has been disclosed in the prior art that is configured so that it does not roll. The cylinder includes a body that is triangular in cross section having sloped panels. The outer surface of the body is circumscribed with longitudinally extending channels that direct the flow of water evenly over its surface. Included on the cylinder body, on adjacent panels, are elongated recesses and cowls that serve as finger-gripping handles. However, the longitudinal channels do not prevent damage to the gas cylinder, and the handles must be molded, cast or otherwise formed into the body of the gas cylinder.

Accordingly, there is a need for a gas cylinder that is resistant to damage to the cylinder wall. Also, there is a need for a device that allows the cylinder to be easily lifted and moved from one location to another.

### SUMMARY OF THE INVENTION

The present invention is directed to gas cylinders such as, but not limited to, mixed gas cylinders, compressed air cylinders, oxygen cylinders, carbon dioxide cylinders and acetylene cylinders. Such gas cylinders that may be adapted with the present invention include, but are not limited to, scuba cylinders, medical cylinders, industrial cylinders and paintball cylinders.

The gas cylinder of the present invention includes ribs added to the outside diameter of the body of the cylinder, which may be made from an aluminum alloy, steel or other suitable material. The ribs run the longitudinal length of the gas cylinder, beginning at or near the shoulder (below the valve stem) of the gas cylinder. The ribs continue along the outside wall of the gas cylinder to proximate the base of the cylinder. The ribs may be formed on or within the wall of the gas cylinder by backward impact extrusion, or other suitable metallurgical processes known to those of ordinary skill in the art. The gas cylinder may be configured with various outside diameters (e.g., from about three inches to about ten inches) and with various lengths (e.g., from about nine inches to about fifty inches) so as to adapt the present invention to various uses of such cylinders.

Additional improvements to the prior art gas cylinders in accordance with the present invention include a valve protector and a carrier having a roller. The valve protector may also be used as a lifting handle. The valve protector is conical in shape, having an opening in the base (wider end) sufficient to fit over the valve stem of the gas cylinder. The top (narrow end) of the valve protector may also be open to engage the top of the valve stem, and may be removably secured to the valve stem by a split retaining ring. The valve protector further has a partial cutout on a first side of its body that connects to the valve protector's open base for easy connection of a hose or other connector to the valve. The valve protector may have a substantially rectangular cutout on a second side of the body of the valve protector. The valve protector may be made from any suitable material strong enough to protect the valve stem from damage, for example, aluminum alloys, steel alloys, and thermoplastics.

The gas cylinder carrier of the present invention includes a base having a cylindrical wheel, axle and a wheel support structure. The base and wheel are detachably secured around the outside circumference (wall) of the gas cylinder with a strap having a quick release attachment mechanism, such as hook-and-loop fasteners (VELCRO), a buckle or other suitable device. The wheel and base may be made from any suitable material strong enough to support the gas cylinder during movement, for example, aluminum alloys, steel alloys, thermoplastics and synthetic or natural rubber. The strap may be made from any suitable material strong enough to secure the gas cylinder to the wheel base during movement.

The advantages for configuring the gas cylinder with the ribs of the present invention include, but are not limited to: (i) better structure design than existing designs; (ii) the ribs will protect a foreign object hitting the outside diameter of the cylinder from being used in service; and (iii) handling the ribbed cylinder when wet or dry is easier than the existing design. The advantages for adding a valve protector include, but are not limited to: (i) increased safety when using a gas cylinder since the valve protector will protect the valve from being damaged or broken off thereby preventing a serious accident; (ii) carrying the cylinder or pulling the cylinder with a wheel support roller attached with a hook-and-loop fastener around the diameter proximate the bottom of cylinder; and (iii) helping a diver in distress by pulling the diver using the hand grip valve protector.

Other features and advantages of the invention will become apparent from the accompanying drawings, which illustrate, by way of example, the features of the invention.

### BRIEF DESCRIPTION OF THE DRAWINGS

FIG. 1 is a side plan view of a ribbed gas cylinder in accordance with the present invention having a wheeled support assembly.

FIG. 2 is a side plan view in partial cross-section of a gas cylinder in accordance with the present invention having a plurality of longitudinal ribs.

FIG. 3 is a side plan view in cross-section of the top end of a gas cylinder in accordance with the present invention.

FIG. 4 is a top plan view of a gas cylinder having equally spaced ribs in accordance with the present invention.

FIG. 5A depicts a perspective view of a valve protector having a handle in accordance with one aspect of the present invention.

FIG. 5B depicts a perspective view of an alternative valve protector in accordance with another aspect of the present invention.

FIG. 6 depicts a top plan view of a retaining ring of the present invention.

FIG. 7A is a perspective view of a wheeled support assembly for the bottom of a gas cylinder in accordance with the present invention.

FIG. 7B is a side plan view of a wheeled support assembly and attachment system for the bottom of a gas cylinder in accordance with the present invention.

### DETAILED DESCRIPTION OF THE INVENTION

The present invention is directed to gas cylinders such as, but not limited to, mixed gas cylinders, compressed air cylinders, oxygen cylinders, carbon dioxide cylinders and acetylene cylinders. Such gas cylinders that may be adapted with the present invention include, but are not limited to, scuba tanks, medical cylinders, industrial cylinders and paintball cylinders.

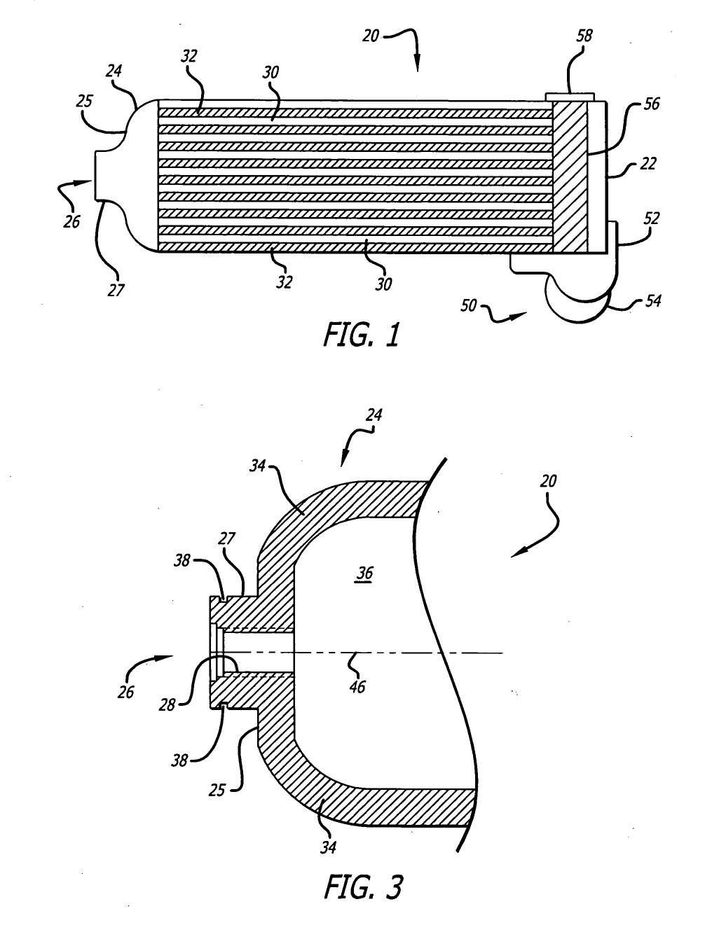

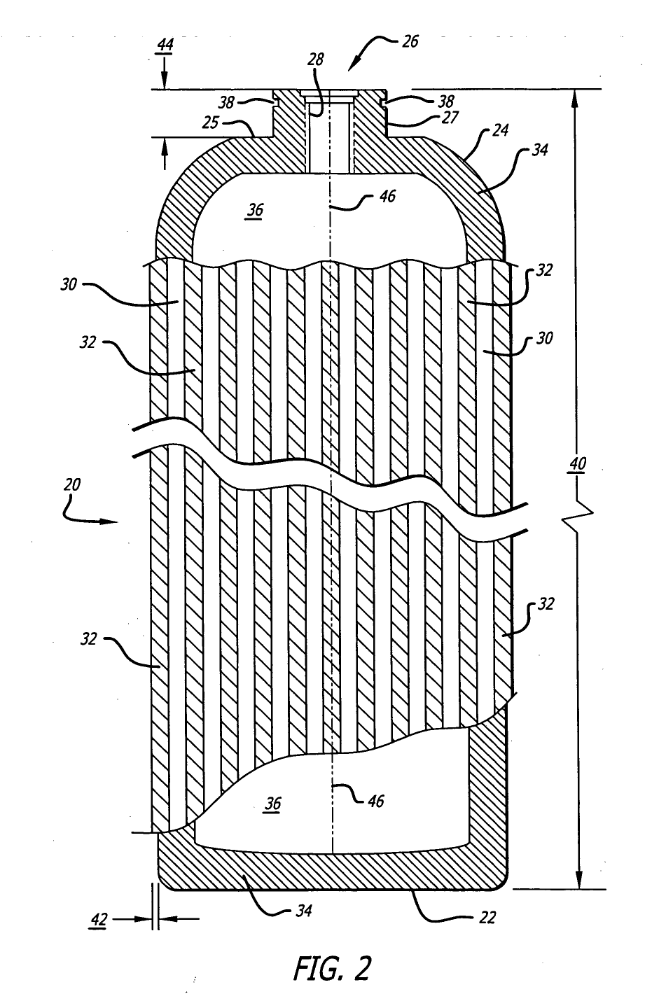

Referring now to FIG. 1, the gas cylinder 20 of the present invention includes a bottom end 22 and a top end 24 and a cylindrical wall (outside surface) disposed between the two ends so as to form the cylinder. The body 34 of the cylinder or tank is formed with raised ribs 32 that extend longitudinally from proximate the top of the cylinder to proximate the bottom of the cylinder. The longitudinal ribs may be substantially equally spaced circumferentially along the outside wall of the cylinder. As shown in FIG. 2, the body of the cylinder wall is generally hollow forming a cavity 36 within the cylinder so as to hold gas or other fluid. The gas cylinder of the present invention may be made from an aluminum alloy (for example, alloys designated by the standards ASTM 6061-T6 and ASTM 7075-T6), steel or other suitable material for maintaining a desired volume of gas under a desired pressure. The thickness of the wall of the cylinder body is typically in the range of 0.5 to 0.6 inches (1.27 to 1.52 centimeters) for aluminum alloys and 0.3 to 0.4 inches (0.76 to 1.01 centimeters) for steel.

As shown in FIG. 3, the top portion 24 of the gas cylinder 20 may include a flange or neck portion 27 that may be configured to retain a valve having a valve stem (not shown). The neck of the cylinder may be configured as cylindrical or other suitable shape about a central line 46 of the cylinder. The neck may further include a lumen 28 having threads or other mechanism for retaining the valve stem. The neck is configured with a opening or hole 26 for inserting the valve stem or other metering device into the cylinder. The upper portion of the cylinder may also be configured with a substantially (relatively) flat upper surface 25 that surrounds the neck of the cylinder. The upper portion of the cylinder may have a rounded shoulder that provides a substantially smooth transition from the flat upper surface to the vertical sidewall of the cylinder. The neck portion of the cylinder may also be configured with a circular or annular slot 38 for housing a retaining ring or similar device (FIG. 6). The neck is configured with a diameter, for example, about 2.3 inches (5.8 centimeters), and a height 44, for example, of about 1.0 inches (2.54 centimeters), that provide sufficient structural support to retain a valve stem inserted (or partially inserted) into the threaded opening 26 of the neck. Accordingly, the hole 26 and lumen 28 in the cylinder neck are configured with a diameter and length suitable for safely retaining a gas valve stem.

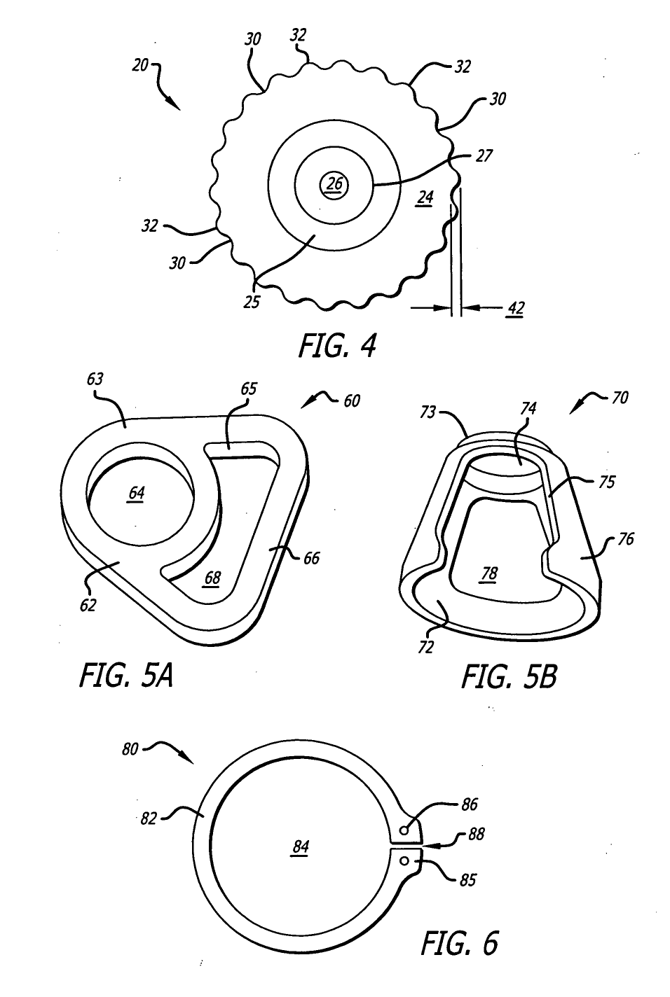

As shown in FIGS. 2 and 4, the cylinder 20 of the present invention includes a plurality of contoured (arcuate, curved, semi-circle, pointed or other suitable shape) raised ribs 32 that extend longitudinally along the surface 30 of the cylinder. The raised ribs may be formed on or within the wall of the gas cylinder by backward impact extrusion, or other suitable metallurgical processes known to those of ordinary skill in the art. Each rib may be equally spaced from each adjacent rib. Thus, a gas cylinder having a diameter of about 7.25 inches (18.4 centimeters) will have about thirty-six ribs. As shown in FIGS. 2 and 4, the raised ribs have a height 42 above the surface of the cylinder of approximately 0.03 to 0.04 inches (0.076 to 0.01 centimeters), and are formed with a radius of about 0.5 inches (1.27 centimeters). The overall length 40 of the cylinder will vary with the desired gas storage capacity of the cylinder. For example, for a scuba tank having a diameter of about 7.25 inches (18.4 centimeters), the cylinder length would be about twenty-six inches (66 centimeters) for a capacity of eighty cubic feet (2.3 cubic meters), about nineteen inches (48 centimeters) for a capacity of fifty cubic feet (1.4 cubic meters), and about thirteen inches (33 centimeters) for a capacity of thirty-five cubic feet (0.99 cubic meters). For a particular material of construction (for example, aluminum or steel), those of ordinary skill in the art will readily appreciate the required thickness of the body 34 of the cylinder wall required to safely maintain the compressed gas within the cylinder without danger of rupturing the cylinder wall, for example, the wall thickness may be about 0.5 inches (1.27 centimeters) for aluminum alloys to provide a service of about three thousand pounds per square inch (20680 kilopascals).

Referring now to FIGS. 5A and 5B, the cylinder may be provided with a valve protector and or handle mechanism. As shown in FIG. 5A, a valve protector 60 may be configured with a main body 62 having a portion 63 that forms a circular or annular cutout 64. The valve protector may be further configured in a triangular shape having a handle portion 66 that includes a cutout 66 in which the user may place its fingers or parts of its hand to pull the cylinder. Alternatively, a valve protector 70 may be configured having a conical (frustum) shape with a main body 72 having an upper portion 73 forming a circular or annular cutout 74. The body portion may be further configured with a cutout portion 75 having an opening 78 for a valve stem or other portion of a regulator or similar device. The valve protector may be made from aluminum or an alloy thereof, steel or other iron alloy, a thermoplastic material, a natural or synthetic rubber, a polymer or other suitable material strong enough to protect the valve from damage. The valve protector may be configured to be about five inches (12.7 centimeters) in length and may have an inside diameter of about two inches (5.08 centimeters), or may be configured with other lengths and diameters to adapt to the size of a particular gas cylinder and valve stem.

As shown in FIG. 6, a retaining ring 80 may be configured for positioning within the annular slot 38 in the neck 27 formed on the upper portion 24 of the cylinder 20. The retaining ring is generally circular having flanged ends 85 having punched or otherwise formed holes 86 so as to secure the ends of the retaining ring. The ends of the retaining ring form a slot 88 that may be widened to slidably fit over the neck of the cylinder and into the annular slot. The retaining ring preferably has an inside diameter about the same as the outside diameter of the slot in the neck of the cylinder, for example, about two inches (5.1 centimeters). The width of the body of the retaining ring is preferably about the same as the depth of the slot in the neck, for example, about 0.2 inches (0.5 centimeters). The retaining ring may be made from brass, aluminum or an alloy thereof, steel or other iron alloy, a thermoplastic material, a natural or synthetic rubber, a polymer or other suitable material strong enough to hold the valve protector in place, but pliable enough so that the end of the retaining ring may be spread apart so as to be position with the slot in the cylinder neck.

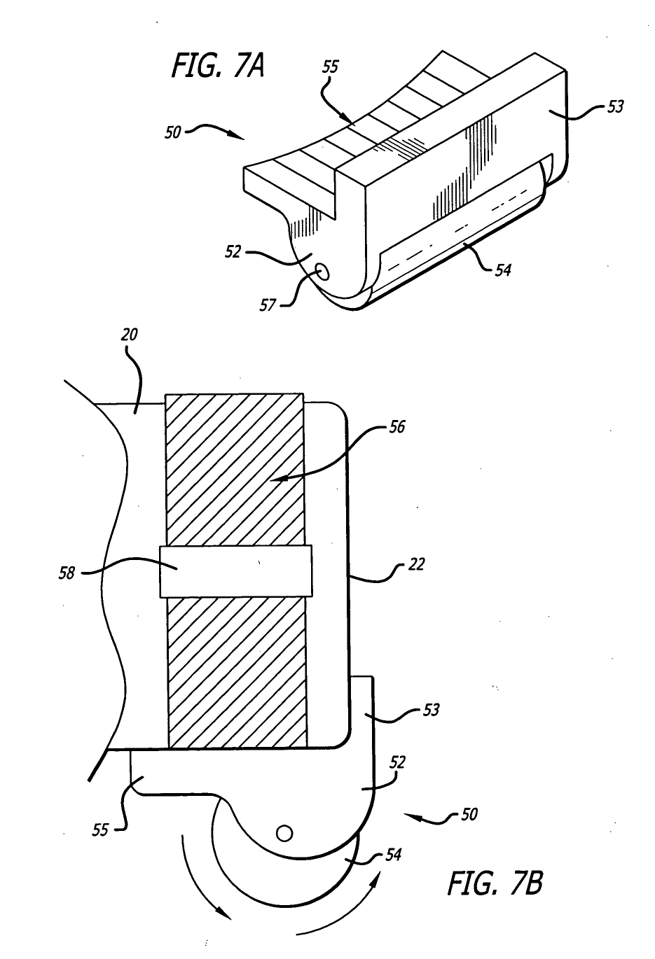

Referring to FIGS. 7A and 7B, a pedestal 54 supporting and moving the gas cylinder is configured to adapt to the bottom portion 22 of the gas cylinder 20. The pedestal includes a main wheel support section having a seat 55 for retaining the bottom of the cylinder. The wheel support further includes a flange 53 for buttressing against the bottom of the cylinder. The pedestal further includes a wheel 54 having an axle 57 or other mechanism for rotatably securing the wheel to the pedestal. The wheel and axel are disposed within the wheel support portion of the pedestal. The pedestal and wheel and may be made from aluminum or an alloy thereof, steel or other iron alloy, a thermoplastic material, a natural or synthetic rubber, a polymer or other suitable material strong enough to support the gas cylinder. The cylinder pedestal may be further configured with a strap 56 for the body of the cylinder. The strap may be configured wotj a tightening and fastening mechanism 58 such as hook-and-loop fasteners (Velcro), a buckle or other suitable device. The strap may be made from leather, canvas, a natural or synthetic fabric, a plastic material, a natural or synthetic rubber, a polymer or other suitable material strong enough to hold the cylinder on the pedestal during transport. The strap may be detachable for the pedestal and the buckle or fastener may be detachable from the strap.

While this specification describes particular embodiments of the present invention, those of ordinary skill can devise variations of the present invention, including different dimensions and materials of construction, without departing from the inventive concept. Accordingly, it is not intended that the invention be limited except by the appended claims.

1. A cylinder, comprising a body having a plurality of longitudinal ribs configured on and raised above an outside wall of the body.

2. The cylinder of claim 1, wherein the longitudinal ribs are arcuate in shape.

3. The cylinder of claim 2, wherein the longitudinal ribs have a height of about 0.03 inches to about 0.04 inches.

4. The cylinder of claim 3, wherein the longitudinal ribs have a radius of about 0.5 inches and are substantially equally spaced from each adjacent rib.

5. The cylinder of claim 4, wherein the body of the cylinder includes a first end and a second end, and wherein the longitudinal ribs extend from proximate the first end to proximate the second end.

6. The cylinder of claim 5, further comprising a cylindrical neck formed on the first end of the cylinder body, wherein the neck is configured with an opening and a lumen for housing a valve having a valve stem.

7. The cylinder of claim 6, further comprising a substantially flat surface surrounding the neck, and a shoulder that provides a substantially smooth transition from the flat surface surrounding the neck to the outside wall of the cylinder.

8. The cylinder of claim 1, wherein each longitudinal rib is curved, is about 0.03 inches high, is about 0.5 inches wide and is equally spaced from each adjacent rib.

9. The cylinder of claim 1, wherein the body and the longitudinal ribs are formed from steel.

10. The cylinder of claim 1, wherein the body and the longitudinal ribs are formed from an aluminum alloy.

11. The cylinder of claim 10, wherein the aluminum alloy is chosen from the group consisting of alloys defined by standards ASTM 6061-T6 and ASTM 7075-T6.

12. A method of making a cylinder, comprising forming a body having a plurality of longitudinal ribs configured within an outside wall of the body.

13. The method of claim 12, wherein forming the body of the cylinder includes using backward impact extrusion to form the longitudinal ribs.

14. The method of claim 13, wherein forming the body of the cylinder includes using an aluminum alloy.

15. The method of claim 13, wherein forming the body of the cylinder includes using steel.

16. An apparatus for transporting a cylinder having a body including a first end and a second end, a neck formed on the first end of the cylinder body, and a valve partially disposed in an opening of the neck, the apparatus comprising:
a pedestal having a flange and configured to support the second end of the cylinder;
a wheel; and
means for rotatably securing the wheel to the pedestal.

17. The apparatus of claim 16, further comprising a strap and a fastening device configured so that the pedestal may be removably secured to the cylinder.

18. The apparatus of claim 16, further comprising a valve protector configured to fit over the valve.

19. The apparatus of claim 18, wherein the valve protector is configured with a conical shape.

20. The apparatus of claim 18, wherein the valve protector is configured with a handle portion.
